(19) United States
(12) Patent Application Publication
(10) Pub. No.: US 2012/0253865 A1
(43) Pub. Date: Oct. 4, 2012

(54) SYSTEM AND METHOD FOR OPTIMIZING PLANNING PRODUCTION USING FEATURE DRIVEN VALUE APPROXIMATION TECHNIQUES

(75) Inventors: Srinivas NARASIMHAMURTHY, Bangalore (IN); Durga Prasad MUNI, Orissa (IN)

(73) Assignee: INFOSYS TECHNOLOGIES, LTD., Bangalore (IN)

(21) Appl. No.: 13/221,164

(22) Filed: Aug. 30, 2011

(30) Foreign Application Priority Data
Mar. 31, 2011 (IN) 1050/CHE/2011

(51) Int. Cl. G06Q 10/06

(52) U.S. Cl. 705/7.12

(57) ABSTRACT

A system and method is disclosed of implementing a production planning module that is configured to optimize overall costs associated with reconfiguring a production facility during a changeover between to produce a another product family over a plurality of cycles. User input data is received via a user interface and a first state vector is created and is representative of a first product family and a first inventory of items of all product families manufactured at the production facility. A first action vector is created of a first quantity of items to be produced of the first product family in a first current cycle and a second product family to be produced in a second cycle. A first state-action value function is calculated for the first action vector in a first iteration and incorporates a first sampled demand of the first inventory items of the product families, a first inventory cost associated with the first inventory and a first set up cost. A second state vector is created based on the first state vector, the first action vector and the first sampled demand. The second state vector is made of a second inventory of items of all the product families. The method comprises creating a second action vector of a second quantity of items to be produced of the second product family in the second cycle and a third product family to be produced in a third cycle. A second state-action value function is calculated for the second action vector, a second sample demand of items, a second inventory cost associated with production of the second quantity of items and a second set up cost associated with reconfiguration of the production facility from producing the second product family to producing the third product family. A cost optimization result policy is output by minimizing, over all actions vectors, the first state-action value function in the user interface.

This application claims the benefit of Indian Patent Application Filing No. 1050/CHE/2011, filed Mar. 31, 2011, which is hereby incorporated by reference in its entirety.

### FIELD

The present disclosure relates to a system and method for optimizing planning production taking into account stochastic factors and using feature driven value approximation techniques.

### BACKGROUND

Industrial production is a multi-billion dollar business which affects every individual and business and is engrained in every aspect of society. Current industrial production planning systems do not explicitly recognize or account for uncertainty. However, in order to cope with uncertainty, various reactive strategies and tactics such as safety stocks, re-planning, flexible capacity, backlog management have been used. There is substantial inefficiency in the deployment of these tactics. Hence beyond explicit characterization of the uncertainties, proactive tactical decisions such as customer service times, inventory buffers, capacity buffers and planned lead times provide counter-measures to the uncertainty.

Recently, there has been increasing interest in adding uncertainty or stochastic factors to the production planning strategy models. Although much analysis has been performed to examine the applicability of stochastic factor to, programming methods, there are significant limitations and the resulting plans are difficult to implement.

In particular, a common production facility may include one or more make-to-stock manufacturing systems, wherein each production facility has the capability to produce multiple different product families associated with a single type of product at one time. For instance, a particular facility may have the capability to produce a family of toothpaste products, a family of hair gel products, a family of face cream products and the like. However, these production facilities can only produce products belonging to one product family at a time. For instance, a production facility will plan for produce a desired number of units of toothpaste products, in which the products can have different weights, packagings, flavors and the like over set amount of time (e.g. a single week and the like). Accordingly, when the desired amount of units of a particular family is produced, the production facility will need to be reconfigure or changeover its setup to begin producing a desired number of units of products in another product family (e.g. hair gels).

However, there are set up costs associated with reconfiguring the production facility to begin producing another product family. Further, the set up costs based on the sequence of products to be produced may vary depending on which product family will be produced next, as costs vary based on different and/or additional equipment being used, manufacturing processes adjusted and the like. For example, it may be more expensive to change over from toothpaste products to hair gel products than to change over to facial cream products.

Additionally, there may be problems if the demand for one or more particular products exceeds the number of units which have been produced for those products. For instance, the facility may receive an unexpected urgent order for a product family which the facility is not currently producing. Although the facility can prepare for such circumstances by producing extra units, these excess units must be maintained in inventory until enough orders are received. This holding of excess units results in extra costs. Therefore, problems arise due to sequencing and lot-sizing of chosen product families, while responding to stochastic demands and uncertain production rates. Demands that cannot be satisfied directly from stock is either lost or backlogged until the product becomes available after production.

What is needed is a system and method for optimizing planning production taking into account stochastic factors and using feature driven value approximation techniques.

### SUMMARY

In an aspect, a method is disclosed of implementing a production planning module that is configured to optimize overall costs associated with reconfiguring a production facility during a changeover between to produce a another product family over a plurality of cycles. The method comprises receiving user input data via a user interface. The method comprises creating a first state vector based on at least a portion of the received user input data, wherein the first state vector is representative of a first product family and a first inventory of items of all product families manufactured at the production facility. The method comprises creating a first action vector based on at least a portion of the received user input data, wherein the first action vector is representative of a first quantity of items to be produced of the first product family in a first current cycle and a second product family to be produced in a second cycle. The method comprises calculating, using one or more processors, a first state-action value function for the first action vector in a first iteration, wherein the first state-action value function incorporates values associated with a first sampled demand of the first inventory items of the product families, a first inventory cost associated with the first inventory and a first set up cost associated with reconfiguring the production facility from producing the first product family to producing the second product family. The method comprises creating a second state vector based on the first state vector, the first action vector and the first sampled demand. The second state vector is representative of the second product family and a second inventory of items of all the product families manufactured at the production facility. The method comprises creating a second action vector based on at least a portion of the received user input data, wherein the second action vector is representative of a second quantity of items to be produced of the second product family in the second cycle and a third product family to be produced in a third cycle. The method comprises calculating, using one or more processors, a second state-action value function for the second action, wherein the second state-action value function incorporates values associated with a second sample demand of items, a second inventory cost associated with production of the second quantity of items and a second set up cost associated with reconfiguration of the production facility from producing the second product family to producing the third product family. The method comprises outputting a cost optimization result policy obtained by minimizing, over all actions vectors, the first state-action value function in the user interface.

In an aspect, a non-transitory machine readable medium is disclosed which has stored thereon instructions for implementing a production planning module that is configured to optimize overall costs associated with reconfiguring a production facility during a changeover between to produce a another product family over a plurality of cycles. The machine readable medium comprises machine executable code which, when executed by at least one machine, causes the machine to receive user input data via a user interface. The code causes the machine to create a first state vector based on at least a portion of the received user input data, wherein the first state vector is representative of a first product family and a first inventory of items of all product families manufactured at the production facility. The code causes the machine to create a first action vector based on at least a portion of the received user input data, wherein the first action vector is representative of a first quantity of items to be produced of the first product family in a first current cycle and a second product family to be produced in a second cycle. The code causes the machine to calculate a first state-action value function for the first action vector in a first iteration, wherein the first state-action value function incorporates values associated with a first sampled demand of the first inventory items of the product families, a first inventory cost associated with the first inventory and a first set up cost associated with reconfiguring the production facility from producing the first product family to producing the second product family. The code causes the machine to create a second state vector based on the first state vector, the first action vector and the first sampled demand, wherein the second state vector is representative of the second product family and a second inventory of items of all the product families manufactured at the production facility. The code causes the machine to create a second action vector based on at least a portion of the received user input data, wherein the second action vector is representative of a second quantity of items to be produced of the second product family in the second cycle and a third product family to be produced in a third cycle.

The code causes the machine to calculate a second state-action value function for the second action, wherein the second state-action value function incorporates values associated with a second sample demand of items, a second inventory cost associated with production of the second quantity of items and a second set up cost associated with reconfiguration of the production facility from producing the second product family to producing the third product family. The code causes the machine to output a cost optimization result policy obtained by minimizing, over all actions vectors, the first state-action value function in the user interface.

In an aspect, a computer system comprises a memory and a processor coupled to the memory. The processor is operative to receive user input data via a user interface. The processor is operative to create a first state vector based on at least a portion of the received user input data, wherein the first state vector is representative of a first product family and a first inventory of items of all product families manufactured at the production facility. The processor is operative to create a first action vector based on at least a portion of the received user input data, wherein the first action vector is representative of a first quantity of items to be produced of the first product family in a first current cycle and a second product family to be produced in a second cycle. The processor is operative to calculate a first state-action value function for the first action vector in a first iteration, wherein the first state-action value function incorporates values associated with a first sampled demand of the first inventory items of the product families, a first inventory cost associated with the first inventory and a first set up cost associated with reconfiguring the production facility from producing the first product family to producing the second product family. The processor is operative to create a second state vector based on the first state vector, the first action vector and the first sampled demand, wherein the second state vector is representative of the second product family and a second inventory of items of all the product families manufactured at the production facility. The processor is operative to create a second action vector based on at least a portion of the received user input data, wherein the second action vector is representative of a second quantity of items to be produced of the second product family in the second cycle and a third product family to be produced in a third cycle. The processor is operative to calculate a second state-action value function for the second action, wherein the second state-action value function incorporates values associated with a second sample demand of items, a second inventory cost associated with production of the second quantity of items and a second set up cost associated with reconfiguration of the production facility from producing the second product family to producing the third product family. The processor is operative to output a cost optimization result policy obtained by minimizing, over all actions vectors, the first state-action value function in the user interface.

In one or more of the above aspects, in calculating the first state-action value function, a holding cost is determined for an item of the first product family held in inventory after the demand for the item has been fulfilled.

In one or more of the above aspects, a value-function approximation vector is calculated based at least on the first state vector and the first action vector. The first state-action value function is modified using the value-function approximation vector in a second iteration. In one or more of the above aspects, the first and/or the second sampled demand is sampled from a probability distribution. In one or more of the above aspects, the input data further comprises a user defined number of iterations, a user defined number of cycles; and an overall time horizon over which the state-action value function is updated. In one or more of the above aspects, a step size value is determined and incorporated into the cost optimization result policy.

### BRIEF DESCRIPTION OF THE DRAWINGS

FIG. 1 illustrates a diagram of an example system environment that allows operation of a production planning module in accordance with an aspect of the present disclosure;

FIG. 2A illustrates a block diagram of a client device implementing at least a portion of the production planning module in accordance with an aspect of the present disclosure;

FIG. 2B illustrate a block diagram of a server implementing at least a portion of the production planning module in accordance with an aspect of the present disclosure;

FIG. 3 illustrates a block diagram of the production planning module in accordance with an aspect of the present disclosure; and

FIGS. 4A and 4B illustrate is an example flow chart diagram depicting portions of processes performed by production planning module in accordance with the present disclosure.

### DETAILED DESCRIPTION

Generally, the system and method is configured to optimize the long term total average cost in producing new product families at a particular production facility after a change-over event. The costs include, but are not limited to, the set up costs for reconfiguring the production line to switch production from one product family to another product family; the costs associated with lost profits and revenues incurred as a results of a shortage in one or more product families; and costs resulting from excess units of one or more product families being held in inventor until they are shipped.

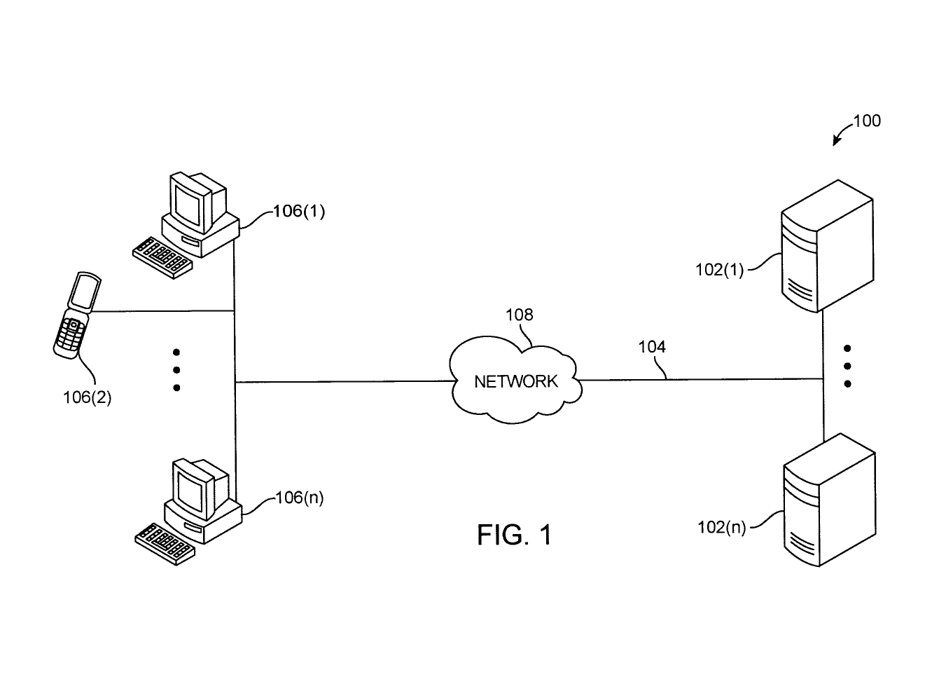

FIG. 1 illustrates a diagram of an example system environment that implements and executes a novel system and method for optimizing planning production taking into account stochastic factors and using feature driven value approximation techniques in accordance with an aspect of the present disclosure. In particular, the example system environment 100 includes one or more servers 102(1)-102(n). The environment 100 includes one or more client devices 106(1)-106(n), although the environment 100 could include other numbers and types of devices in other arrangements. It should be noted that the term “network devices” can be referred to as encompassing one or more client devices, one or more servers and/or other hardware components in the system 100.

The servers 102(1)-102(n) are connected to a local area network (LAN) 104 and the client devices 106(1)-106(n) are connected to a wide area network 108, whereby the one or more client devices 106(1)-106(n) communicate with the one or more servers 102(1)-102(n) via the wide area network 108 and LAN 104. It should be noted that although the client device and/or server may be referred to herein in the plural, it is contemplated that only one client device and/or one server may be considered without being limiting to the language used herein. It should be understood that the particular configuration of the system 100 shown in FIG. 1 are provided for exemplary purposes only and is thus not limiting.

Client devices 106(1)-106(n) comprise computing devices capable of connecting to other computing devices, such as the servers 102(1)-102(n). Such connections are performed over wired and/or wireless networks, such as network 108, to send and receive data, such as for Web-based and non Web-based requests, receiving responses to requests and/or performing other tasks, in accordance with the novel processes described herein. Non-limiting and non-exhausting examples of such client devices 106(1)-106(n) include, but are not limited to, personal computers (e.g., desktops, laptops), mobile and/or smart phones, kiosks, industrial machinery computing devices, tablet devices, PDAs and the like.

In an example, client devices 106(1)-106(n) may be configured to run a Web browser or other software module that provides a user interface for human users to interact with, request resources and/or information, as well as submit instructions over the network 108 to the one or more servers 102(1)-102(n) via Web-based or non Web-based applications. One or more Web-based or non Web-based applications may accordingly run on the servers 102(1)-102(n) that provide the requested data to the client device 106(1)-106(n) and/or perform the requested instructions on behalf of the user.

Network 108 comprises a publicly accessible network, such as the Internet, which handles communication between the client devices 106(1)-106(n) and the servers 102(1)-102(n). However, it is contemplated that the network 108 may comprise other types of private and public networks. Communications, such as requests from client devices 106(1)-106(n) and responses from servers 102(1)-102(n), preferably take place over the network 108 according to standard network protocols, such as the HTTP, UDP, and TCP/IP protocols and the like.

Further, it should be appreciated that the network 108 may include local area networks (LANs), wide area networks (WANs), direct connections and any combination thereof, as well as other types and numbers of network types. On an interconnected set of LANs or other networks, including those based on differing architectures and protocols, routers, switches, hubs, gateways, bridges, and other intermediate network devices may act as links within and between LANs, WANs and other networks to enable messages and other data to be sent and received between network devices. Also, communication links within and between LANs and other networks typically include twisted wire pair (e.g., Ethernet), coaxial cable, analog telephone lines, mobile cell towers, full or fractional dedicated digital lines including T1, T2, T3, and T4, Integrated Services Digital Networks (ISDNs), Digital Subscriber Lines (DSLs), wireless links including satellite links and other communications links known to those skilled in the relevant arts. LAN 104 may comprise one or more private and public networks which provide secured access to the servers 102(1)-102(n).

The servers 102(1)-102(n) comprise one or more network devices or machines capable of operating one or more Web-based and/or non Web-based applications that may be accessed by other network devices (e.g. client devices, other servers) in the network 108. Such data includes, but is not limited to Web page(s), image(s) of physical objects, user account information, and any other objects and information. It should be noted that the servers 102(1)-102(n) may perform other tasks and provide other types of resources.

As will be discussed in more detail below, one or more servers 102 may comprise a cluster of a plurality of servers which are managed by a network traffic management device (e.g. firewall, load balancer, web accelerator), gateway device, router, hub and the like. In an aspect, one or more servers 102(1)-102(n) may implement a version of Microsoft® IIS servers, RADIUS servers and/or Apache® servers, although other types of server software may be used and other types of applications may be available the on servers 102(1)-102(n).

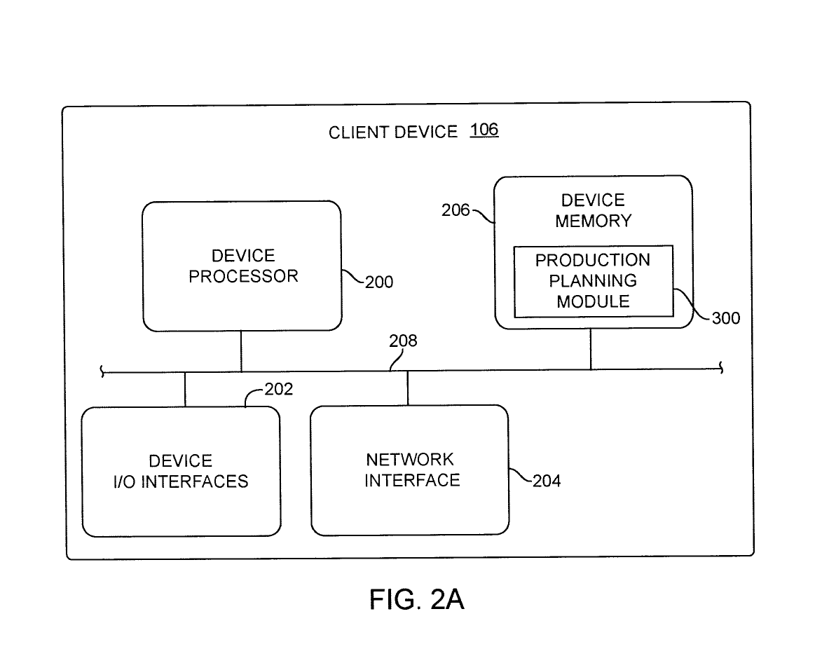

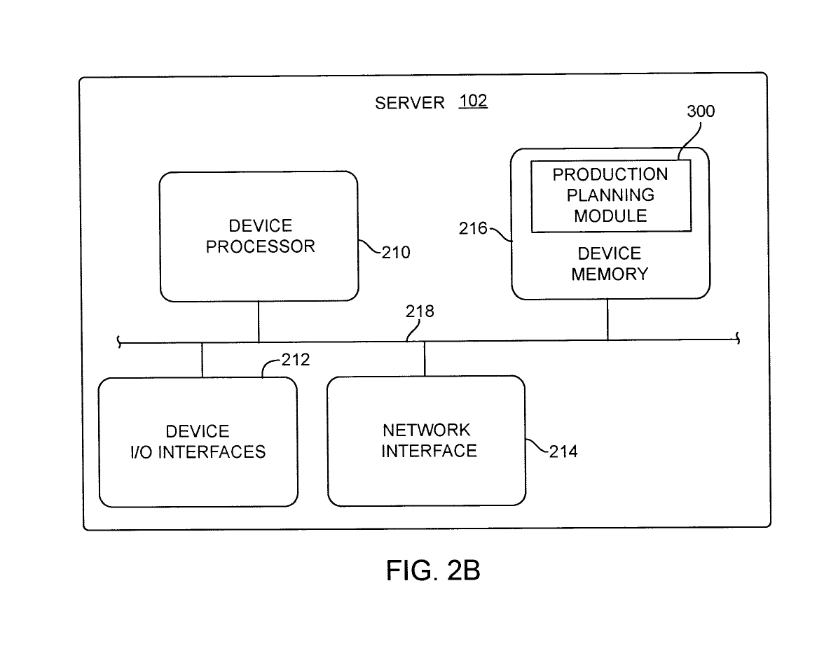

FIG. 2A illustrates a block diagram of a client device 106 shown in FIG. 1 in accordance with an aspect of the present disclosure. As shown in FIG. 2A, an example client device 106 includes one or more device processors 200, one or more device I/O interfaces 202, one or more network interfaces 204 and one or more device memories 206, all of which are coupled together by one or more buses 208. It should be noted that the device 106 could include other types and numbers of components.

FIG. 2B illustrates a block diagram of a server 102 shown in FIG. 1 in accordance with an aspect of the present disclosure. With regard to FIG. 2B, an example server 102 is shown which includes one or more device processors 210, one or more device I/O interfaces 212, one or more network interfaces 214 and one or more device memories 216, all of which are coupled together by one or more buses 218. It should be noted that the server 102 could include other types and numbers of components.

Device processor 200, 210 comprises one or more microprocessors configured to execute computer/machine readable and executable instructions stored in the respective local device memory 206, 216 or in a remote device memory (not shown). Such instructions are implemented by the processor 200, 210 to perform one or more functions described below. It is understood that the processor 200, 210 may comprise other types and/or combinations of processors, such as digital signal processors, micro-controllers, application specific integrated circuits (“ASICs”), programmable logic devices (“PLDs”), field programmable logic devices (“FPLDs”), field programmable gate arrays (“FPGAs”), and the like. The processor 200, 210 is programmed or configured to execute the process in accordance with the teachings as described and illustrated herein of the novel system and method described below.

Device I/O interfaces 202, 212 comprise one or more user input and output device interface mechanisms. The interface may include a computer keyboard, touchpad, touchscreen, mouse, display device, and the corresponding physical ports and underlying supporting hardware and software to enable communications with other network devices in the system 100. Such communications include, but are not limited to, accepting user data input and providing output information to a user, programming, accessing one or more memory devices and administering one or more functions to be executed by the corresponding device and the like.

Network interface 204, 214 comprises one or more mechanisms that enable the client devices 106 and/or the servers 102 to engage in TCP/IP or other communications over the LAN 104 and network 108. However, it is contemplated that the network interface 204, 214 may be constructed for use with other communication protocols and types of networks. Network interface 204, 214 is sometimes referred to as a transceiver, transceiving device, or network interface card (NIC), which transmits and receives network data packets over one or more networks, such as LAN 104 and network 108.

In an example where the client device 106 and/or server 102 includes more than one device processor 200, 210 (or a processor 200, 210 has more than one core), each processor 200, 210 (and/or core) may use the same single network interface 204, 214 or a plurality of network interfaces 204, 214 to communicate with other network devices. Further, the network interface 204, 214 may include one or more physical ports, such as Ethernet ports, to couple its respective device with other network devices in the system 100. Moreover, the network interface 204, 214 may include certain physical ports dedicated to receiving and/or transmitting certain types of network data, such as device management related data for configuring the respective device, and the like.

Bus 208, 218 may comprise one or more internal device component communication buses, links, bridges and supporting components, such as bus controllers and/or arbiters. The bus enable the various components of the device 102, 106, such as the processor 200, 210, device I/O interfaces 202, 212, network interface 204, 214, and device memory 206, 216, to communicate with one another. However, it is contemplated that the bus may enable one or more components of its respective device 102, 106 to communicate with components in other devices as well. Example buses include HyperTransport, PCI, PCI Express, InfiniBand, USB, Firewire, Serial

ATA (SATA), SCSI, IDE and AGP buses. However, it is contemplated that other types and numbers of buses may be used, whereby the particular types and arrangement of buses will depend on the particular configuration of the device 102, 106 which houses the bus.

Device memory 206, 216 of the client device 106 or server 102 comprises computer readable media, namely computer readable or processor readable storage media, which are examples of machine-readable storage media. Computer readable storage/machine-readable storage media may include volatile, nonvolatile, removable, and non-removable media implemented in any method or technology for storage of information. Such storage media stores computer readable/machine-executable instructions, data structures, program modules and components, or other data, which may be obtained and/or executed by one or more processors, such as device processor 200, 210. Such stored instructions allow the processor to perform actions, including implementing an operating system for controlling the general operation of the client device 106 and/or server 102 to perform one or more portions of the novel process described below.

Examples of computer readable storage media include RAM, BIOS, ROM, EEPROM, flash/firmware memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Such desired information includes data and/or computer/machine-executable instructions and which can be accessed by the network devices 102, 106.

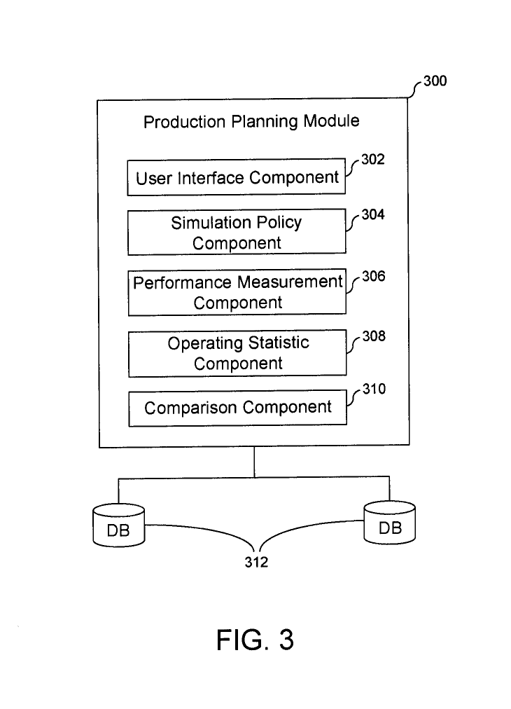

FIG. 3 illustrates a block diagram representing a production planning module in accordance with an aspect of the present disclosure. In particular, the production planning module 300 includes a user interface component 302, a simulation policy component 304, a performance measurement component 306, an operating statistic component 308 and a comparison component 310. It should be noted that the production planning module 300 shown in FIG. 3 is exemplary and may include additional, lesser and/or different components from that which is shown.

The user interface component 302 of the production planning module 300 provides a graphical user interface through which one or more users are able to input data that correspond to production planning functions handled by module 300. Additionally, the user interface component 302 is configured to display output results computed by the production planning module 300 which can then be viewed, printed and/or shared among one or more users. The output results may be displayed via the user interface component 302 in the form of numerical values represented in table form, graphs, charts and the like.

The simulation policy component 304 of the production planning module 300 is configured to process the input data provided by the user and simulate and compute optimized policies relating to production planning and costs associated with producing and/or changing over among or between product families over a desired amount of time. Details of the functions performed by the simulation policy component 304 are described in more detail below.

The results provided by the simulation policy component 304 can be analyzed and processed by the performance measurement component 306, operating statistic component 308 and comparison component 310 of the production planning module 300. Details of the functions performed by these components 306, 308, 310 are described in more detail below.

As shown in FIG. 3, the production planning module 300 is able to store and retrieve information which is input by a user via the user interface component 302 or otherwise collected from one or more database memories 312. The database memories 312 can be utilized to store heuristics and other performance data relating to previous and/or current orders and demand statistics, previous and/or current production times and costs as well as other information which can be utilized by the production planning module 300 to perform one or more desired functions. Database memories 312 are well known in the art and hardware characteristics of storage technologies are discussed above.

Focusing on the function of the production planning module 300, the module 300 utilizes input data to compute results which optimize long-term costs associated with the sequencing and lot-size variables which are to be considered during the planning phase when deciding which family product should be produced and how many units of the family product should be produced after production of the previous product family has been completed at the production facility. In an aspect, the production planning module 300 can also be configured to compute and provide results as to which products within the product family, along with the suggested number of units of each product, should be produced.

For example, a production facility is capable of producing N number product families, whereby a product family, Cᵢ is currently under production. Additionally, an inventory vector is represented as Iₖ=<Iᵢ, I₂, . . . , I_{N}>, whereby Iₖ represents the current inventory of family k, as shown in Equation (1) below:

### Equation 1

Iₖ□[Iₘᵢₙ, Iₘₐₓ]

Additionally, the current product capacity/setup and the current inventory as the current state are defined as state vector s=<Cᵢ, I>. Thus, at state vector s, the production facility will need to decide the quantity of units for product family that is currently being produced as well as the identity of the proposed product family which will be produced next. This is defined herein as an action vector a which comprises two components, a=<qᵢ, Cⱼ>, whereby qᵢ is the amount of units that are to be produced for the current product family to be produced and Cⱼ is the next product family that is to be produced. The relationship between the amount of units qᵢ and the inventory Iₖ is qᵢ□[qₘᵢₙ, qₘₐₓ], qₘᵢₙ=Iₘᵢₙ and qₘₐₓ=Iₘₐₓ, Cⱼ□{ 1, 2, . . . , N}.

On sampling the action vector a, the production planning module performs one or more additional iterations for one or more subsequent state vectors, s′. In an aspect, a next state vector s′ will be considered by production planning module as having a capacity Cⱼ, in which j represents all of the proposed product families to be produced. Additionally, the production planning module will update the inventory vector to reflect quantity qᵢ produced for the current product family i and the demands that were satisfied for each family. Also the production planning module takes into account the total cost incurred which includes inventory related costs and the setup costs.

The production planning module 300 is able to implement an objective function algorithm which optimizes the total costs incurred by the production facility over an assigned period of time T. In particular, the production planning module 300 is configured to compute holding costs as shown in Equation (2):

### Equation 2

Holding costᵢ=unit holding costᵢ*Inventoryᵢ−(unit-holding-costᵢ*demandᵢ)/2

In particular, the production planning module 300 is configured to compute shortage costs as shown in Equation (3):

### Equation 3

Shortage costᵢ=customer penalty costᵢ*shortageᵢ.

Further, the production planning module 300 is configured to compute inventory cost which is the sum of holding cost and shortage costs incurred for each product family.

The production planning module 300 is also configured to compute set-up costs that are incurred in response to reconfiguring the production facility to begin producing another product family, such as from Cᵢ to Cⱼ. The production planning module 300 can define a set-up cost matrix [u_{i,j}], where u_{i,j} is the set-up cost incurred for changing production of product family Cᵢ to product family Cⱼ.

With the component costs as described above, the production planning module 300 iteratively performs an objective state-action value function J which optimizes the total accumulated costs for one or more cycles of time/period over a set amount of time T, as shown in Equation (4).

$$J = E [ {\sum }_{i = 1}^{T} \{ \begin{matrix}{\sum }_{i = 1}^{N} {( {h}_{i} * {I}_{i} - {h}_{i} * {d}_{i} / 2 )}^{+} + \\ {\sum }_{i = 1}^{N} {B}_{i} \times {( {d}_{i} - {I}_{i} )}^{+} + Setup\_Cost ( t )\end{matrix} \} ] \qquad Equation 4$$

Where hᵢ is the holding cost for one unit of family i, Iᵢ is the inventory of family i, dᵢ is the demand of family i, Bᵢ is the customer penalty cost per unit of family i, and Setup_Cost(t) is the set-up cost incurred at time t.

Additionally, the planning production module 300 utilizes a value-function approximation technique to provide the user with data which suggests the quantity or number of units (qᵢ) of the current product family and the identity of the proposed next product family to be produced (Cⱼ) after production of the immediately preceding product family has been completed. In particular, the value-function approximation technique utilizes a combination of factors to suggest next product family and unit size information.

In particular to an aspect, the value-function approximation technique can be computed using Equation (5):

$$\tilde{Q} ( s , a , r ) = {\sum }_{k = 1}^{Rlength} r ( k ) {φ}_{k} ( s , a ) \qquad Equation 5$$

In Equation 5 above, \tilde{Q} approximates the value function Q, and where, r(k) represents k^{th} component of the parameter vector r and φₖ is the k^{th} basis function. The parameter vector r=(r(1), r(2), . . . , r(Rlength)) represents actual values. In an aspect, the φₖ basis function can be computed using a variety of different polynomial techniques (e.g. Chebyshev, Hermite, Legendre) and is well known in the art. In an aspect, the Chebyshev polynomial is used herein to explain the functions performed by the production planning module 300. However, it is contemplated that other known polynomial techniques can be used to calculate the φₖ basis function.

In determining the polynomial basis functions for φₖ(x) Equation (6) is used.

### Equation 6

φₖ(x)=Tₗ(x)

In the Equation 6 above, Tₗ is a Chebyshev polynomial of degree l and is defined in Equation 7.

### Equation 7

Tl(x)=cos(l arccos x)

In taking degree l to have iterative values of 1, 2, 3 and 4, the polynomials shown in Equations (8)-(11) are as such:

### Equation 8

T₁(x)=x

### Equation 9

T₂(x)=2x²−1

### Equation 10

T₃(x)=4x³−3x

### Equation 11

T₄(x)=8x⁴−8x²+1

However, as shown in Equation (5), \tilde{Q} is computed using φₖ (s, a) instead of in terms of the mapped value x. Accordingly, the mapped value x is computed in terms of factors s and a by the equations discussed below. In particular, the mapped value of x is correlated to basic feature y as shown in Equation (12).

$$x = \frac{y - \frac{1}{2} ( b + d )}{\frac{1}{2} ( b - d )} \qquad Equation 12$$

In Equation (12), b and d are the maximum and minimum values of the feature y. Feature y is correlated to factors s and a by Equations (13)-(15).

$$\begin{matrix}{y}_{1} ( s , a ) = {\sum }_{i = 1}^{N} {I}_{i} & Equation 13 \\ {y}_{2} ( s , a ) = {( {q}_{i} + {I}_{{C}_{j}} )}^{2} & Equation 14 \\ {y}_{3} ( s , a ) = \vert {C}_{j} - {C}_{i} \vert + {I}_{{C}_{j}} & Equation 15\end{matrix}$$

In the Equations (13)-(15), s=<Cᵢ, I₁, I₂, . . . , I_{N}> and a=<qᵢ, Cⱼ>. It should be noted that although only three iterations are only shown, it is contemplated that any number of iterations, and thus polynomials, can be used and computed.

Considering that φₖ (s, a) can now be computed, the simulation policy iterator 304 of the production planning module 300 is able to calculate \tilde{Q} in Equation (5) for an iteration.

However, in an aspect, the simulation policy iterator 304 utilizes sampling based iterative policy learning to perform iterations and update \tilde{Q} after each iteration. Referring back to Equation (5), \tilde{Q} is computed using the parameter vector \vec{r}. The simulation policy iterator 304 is able to control the parameter vector \vec{r} considering that the value function approximation \tilde{Q} is generalized. Accordingly, the simulation policy iterator 304 utilizes Equation (16) to update \vec{r} vector for each iteration.

### Equation 16

\vec{r}←\vec{r}+α∇ᵣ \tilde{Q}(s, πⁿ(s), r)[c(s, πⁿ(s), s′)+γ\tilde{Q}(s′, πⁿ(s′), r)−\tilde{Q}(s, πⁿ(s), r)]

In Equation (16), α is the step size; s′ is the next state that is to be considered, c is the cost incurred going from state s to state s′; and γ is the discount factor. π is an industry policy factor which can be determined using Equation (17).

### Equation 17

π′(s)=argmin_{α}\tilde{Q}(s, a, r)

Since the parameter vector \vec{r} is determined from the actions given by πⁿ in Equation (16), the approximations provided for other actions may not provide the needed accuracy. In an aspect, the policy π can be replaced by a randomized policy, \hat{π} which deviates from π and applies a random action with some positive probability ε.

When the simulation policy component 304 of the production planning module 300 initially starts evaluating a start policy, the state s is initially set to s₀≡Cᵢ, Iₗ⁰, . . . I_{N}⁰). The simulation policy component 304 computes the value function approximation (Equation 5) which updates of the parameter vector \vec{r}. This leads to the gradient scaling of the step sizes, with effective step size γ□ᵣ \tilde{Q} (s, π^{□}(s), \vec{r}). In an aspect, the simulation policy component 304 changes the step size a in each iteration since using a single value for the step size across all parameters can lead to inaccuracies.

The policy evaluation performed by the simulation policy component 304 provides for estimating \vec{r} for a given policy πⁿ≡(qᵢ, Cⱼ), which allows the simulation policy component 304 to improve the policy πⁿ⁺¹. This improved policy is computed on-demand at the given state s^{k}≡(Ci, I₁^{k}, . . . , I_{N}^{k}) by fixing the changeover capacity Cⱼ and computing \tilde{Q}^{j}ₘᵢₙ=min_{qi} \tilde{Q}(s^{k}, qᵢ, Cⱼ, \vec{r}) for each Cⱼ. Then \tilde{Q}ₘᵢₙ=minⱼ[\tilde{Q}^{j}ₘᵢₙ], resulting in <qᵢ, Cⱼ>=arg \tilde{Q}ₘᵢₙ.

In particular, the production planning system, upon initializing the process, will set the current state s=(Cᵢ, I₁, I₂, . . . , I_{N}), action a=(qᵢ, Cⱼ), and demand d=(d₁, d₂, . . . , d_{N}). Additionally, the production planning system will let s′=(Cᵢ′, I₁′, I₂′, . . . , I_{N}′) where Iₖ represents the inventory of the k^{th} family. In an aspect, the production planning system will set the following logic definitions:

Cᵢ′=Cⱼ

Iₖ′=Iₖ−dₖ if k≠Cᵢ

Iₖ′=Iₖ−dₖ+qᵢ if K=Cᵢ

Demand is nearly always considered as an exogenous quantity that is input to the model. In general, the following cases are possible 1) stationary demand 2) non-stationary demand (changing mean with variance as a percentage of the mean, constant mean with increasing variance) 3) demands due to the effects of promotions and other seasonal effects. In an aspect, the sampled demand values are randomly generated using one or more probability distribution methods (e.g. Gaussian distribution) with desired mean and variance values. It should be noted that the historical or standardized demand values can be retrieved from a memory or database, in another aspect.

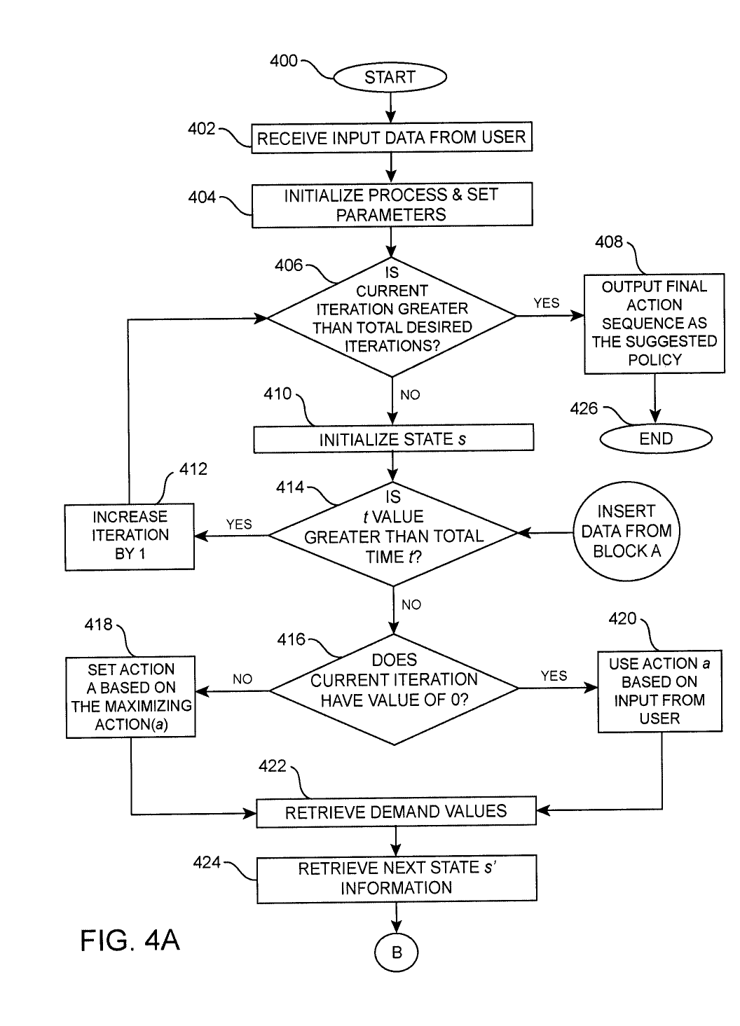

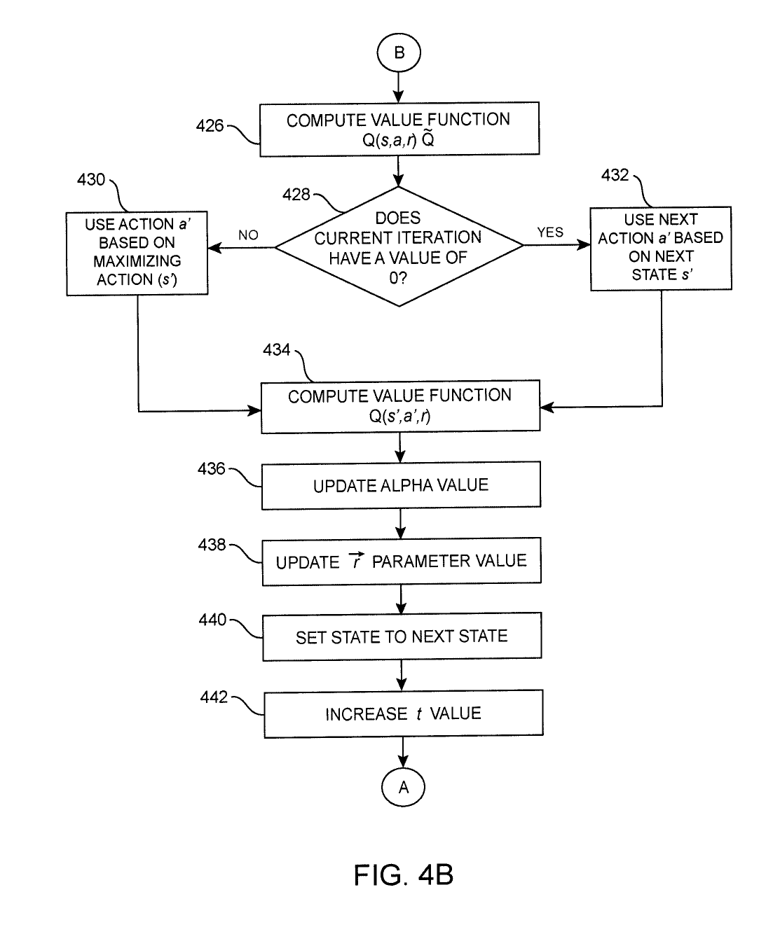

FIGS. 4A and 4B illustrate is an example flow chart diagram depicting portions of processes performed by the production planning module in accordance with the present disclosure. As shown in FIG. 4A, the process begins at Block 400. Thereafter, the production planning module 300 receives a plurality of input data from a user via the user interface module 302 (Block 402).

In an aspect, this received input data is stored in a memory for later retrieval. Such input data includes, but is not limited to, the N number of product families to be produced; total desired number of iterations that the simulation policy iterator component 304 is to perform; the state s which represents the index of the present product family for production as well as the inventories of all N product families; the desired overall time T; and the action a which is the amount of units that the present family is to produce as well as the index of the next product family to produce.

The production planning module 300 thereafter initializes the process and sets the initial parameters (Block 404). Such initial parameters include, but is not limited to, setting the iteration value to zero, setting the initial step size value; setting the discount factor value; and initializing the parameter value r. The production planning module 300 initially checks if the current iteration is greater than the total desired number of iterations that the simulation policy iterator component 304 is to perform (Block 406). If so, the production planning module 300 outputs the final value approximation value via a display for the user to view (Block 408) and the process ends.

In contrast, if the current iteration is not greater than the total desired number of iterations, the simulation policy iterator component 304 initializes the state to be state s and sets a t value to 1 (Block 410). The t value represents the present time or period of production for the particular state s being sampled. The T value represents the total amount of time/total period that is defined by the user, via the user interface, over which the production planning module performs the optimization analysis. Thereafter, the production planning module 300 determines whether the time/period t value is greater than the total time/total period T (Block 414). It should be noted that results from Block A (discussed below) are taken into account at this step.

If the time/period t value is greater than the total time T, the production planning module 300 increases the iteration by a value of 1 and the process returns to Block 406. In contrast, the if the set t value is not greater than the total time T, the production planning module 300 determines if the current iteration has a value of zero (Block 416). If so, the simulation policy iterator component 304 uses the action vector a that was originally input in Block 402 (Block 420). If not, the simulation policy iterator component 304 sets action a to be a maximizing action vector a (Block 420). The maximizing action vector a is one or more actions identified by the production planning module, after performing at least one sampling step, which produces a maximum value function \tilde{Q} for that state vector s.

The simulation policy iterator component 304 generates or retrieves demand values in computing the next state vector s′ (Block 422). In an aspect, the demand values are randomly generated using one or more probability distribution methods (e.g. Gaussian distribution) with desired mean and variance values. It should be noted that the historical or standardized demand values can be retrieved from a memory or database, in another aspect. The simulation policy iterator component 304 also computes the next state s′ information (Block 424). The next state s′ information is computed from the current state s, action a and demand d. The next family Cⱼ is considered as the current family Cᵢ for s′ and the inventories are updated by using demands and quantity qᵢ as described above.

As shown in FIG. 4B, the simulation policy iterator component 304 computes the value function Q as well as the gradient value function \tilde{Q} with respect to the basis function φ (Block 426). Thereafter, the simulation policy iterator component 304 determines if the current iteration has a value of zero (Block 428). If so, the simulation policy iterator component 304 uses action a′ based on the user defined initial policy (Block 432). If not, the simulation policy iterator component 304 sets action a′ based on the maximizing action s′, as discussed above (Block 430).

Thereafter, the simulation policy iterator component 304 computes the value function Q for the a′, s′ and r factors (Block 434) and updates the step size value (Block 436). The simulation policy iterator component 304 also updates the parameter value \vec{r} (Block 438) and sets the state to the next state (Block 440). Further the simulation policy iterator component 304 increases the t value (Block 442), whereby the updated data goes back to Block A in FIG. 4A.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A method of implementing a production planning module configured to optimize overall costs associated with reconfiguring a production facility during a changeover between to produce a another product family over a plurality of cycles, the method comprising:
receiving user input data via a user interface;
creating a first state vector based on at least a portion of the received user input data, wherein the first state vector is representative of a first product family and a first inventory of items of all product families manufactured at the production facility;
creating a first action vector based on at least a portion of the received user input data, wherein the first action vector is representative of a first quantity of items to be produced of the first product family in a first current cycle and a second product family to be produced in a second cycle;
calculating, using one or more processors, a first state-action value function for the first action vector in a first iteration, wherein the first state-action value function incorporates values associated with a first sampled demand of the first inventory items of the product families, a first inventory cost associated with the first inventory and a first set up cost associated with reconfiguring the production facility from producing the first product family to producing the second product family;
creating a second state vector based on the first state vector, the first action vector and the first sampled demand, wherein the second state vector is representative of the second product family and a second inventory of items of all the product families manufactured at the production facility;
creating a second action vector based on at least a portion of the received user input data, wherein the second action vector is representative of a second quantity of items to be produced of the second product family in the second cycle and a third product family to be produced in a third cycle;
calculating, using one or more processors, a second state-action value function for the second action, wherein the second state-action value function incorporates values associated with a second sample demand of items, a second inventory cost associated with production of the second quantity of items and a second set up cost associated with reconfiguration of the production facility from producing the second product family to producing the third product family; and
outputting a cost optimization result policy obtained by minimizing, over all actions vectors, the first state-action value function in the user interface.

2. The method of claim 1 wherein calculating the first state-action value function further comprises:
determining a holding cost for an item of the first product family held in inventory after the demand for the item has been fulfilled.

3. The method of claim 2 further comprising:
calculating a value-function approximation vector based at least on the first state vector and the first action vector;
modifying the first state-action value function using the value-function approximation vector in a second iteration.

4. The method of claim 1, wherein the first sampled demand is sampled from a probability distribution.

5. The method of claim 1, wherein the input data further comprises a user defined number of iterations, a user defined number of cycles; and an overall time horizon over which the state-action value function is updated.

6. The method of claim 1, wherein a step size value is determined and incorporated into the cost optimization result policy.

7. A non-transitory machine readable medium having stored thereon instructions for implementing a production planning module configured to optimize overall costs associated with reconfiguring a production facility during a changeover between to produce a another product family over a plurality of cycles, comprising machine executable code which when executed by at least one machine, causes the machine to:
receive user input data via a user interface;
create a first state vector based on at least a portion of the received user input data, wherein the first state vector is representative of a first product family and a first inventory of items of all product families manufactured at the production facility;
create a first action vector based on at least a portion of the received user input data, wherein the first action vector is representative of a first quantity of items to be produced of the first product family in a first current cycle and a second product family to be produced in a second cycle;
calculate a first state-action value function for the first action vector in a first iteration, wherein the first state-action value function incorporates values associated with a first sampled demand of the first inventory items of the product families, a first inventory cost associated with the first inventory and a first set up cost associated with reconfiguring the production facility from producing the first product family to producing the second product family;
create a second state vector based on the first state vector, the first action vector and the first sampled demand, wherein the second state vector is representative of the second product family and a second inventory of items of all the product families manufactured at the production facility;
create a second action vector based on at least a portion of the received user input data, wherein the second action vector is representative of a second quantity of items to be produced of the second product family in the second cycle and a third product family to be produced in a third cycle;
calculate a second state-action value function for the second action, wherein the second state-action value function incorporates values associated with a second sample demand of items, a second inventory cost associated with production of the second quantity of items and a second set up cost associated with reconfiguration of the production facility from producing the second product family to producing the third product family; and
output a cost optimization result policy obtained by minimizing, over all actions vectors, the first state-action value function in the user interface.

8. The machine readable medium of claim 7, wherein the machine, in calculating the first state-action value function, is configured to determine a holding cost for an item of the first product family held in inventory after the demand for the item has been fulfilled.

9. The machine readable medium of claim 8 wherein the machine is further configured to:
calculate a value-function approximation vector based at least on the first state vector and the first action vector;
modify the first state-action value function using the value-function approximation vector in a second iteration.

10. The machine readable medium of claim 7, wherein the first sampled demand is sampled from a probability distribution.

11. The machine readable medium of claim 7, wherein the input data further comprises a user defined number of iterations, a user defined number of cycles; and
an overall time horizon over which the state-action value function is updated.

12. The machine readable medium of claim 7, wherein a step size value is determined and incorporated into the cost optimization result policy.

13. A computer system comprising:
a memory;
a processor coupled to the memory, the processor operative to:
receive user input data via a user interface;
create a first state vector based on at least a portion of the received user input data, wherein the first state vector is representative of a first product family and a first inventory of items of all product families manufactured at the production facility;
create a first action vector based on at least a portion of the received user input data, wherein the first action vector is representative of a first quantity of items to be produced of the first product family in a first current cycle and a second product family to be produced in a second cycle;
calculate a first state-action value function for the first action vector in a first iteration, wherein the first state-action value function incorporates values associated with a first sampled demand of the first inventory items of the product families, a first inventory cost associated with the first inventory and a first set up cost associated with reconfiguring the production facility from producing the first product family to producing the second product family;
create a second state vector based on the first state vector, the first action vector and the first sampled demand, wherein the second state vector is representative of the second product family and a second inventory of items of all the product families manufactured at the production facility;
create a second action vector based on at least a portion of the received user input data, wherein the second action vector is representative of a second quantity of items to be produced of the second product family in the second cycle and a third product family to be produced in a third cycle;
calculate a second state-action value function for the second action, wherein the second state-action value function incorporates values associated with a second sample demand of items, a second inventory cost associated with production of the second quantity of items and a second set up cost associated with reconfiguration of the production facility from producing the second product family to producing the third product family; and
output a cost optimization result policy obtained by minimizing, over all actions vectors, the first state-action value function in the user interface.

14. The computer system of claim 13, wherein the processor, in calculating the first state-action value function, is configured to determine a holding cost for an item of the first product family held in inventory after the demand for the item has been fulfilled.

15. The computer system of claim 14 wherein the processor is further configured to:
calculate a value-function approximation vector based at least on the first state vector and the first action vector;
modify the first state-action value function using the value-function approximation vector in a second iteration.

16. The computer system of claim 13, wherein the first sampled demand is sampled from a probability distribution.

17. The computer system of claim 13, wherein the input data further comprises a user defined number of iterations, a user defined number of cycles; and an overall time horizon over which the state-action value function is updated. 20

18. The computer system of claim 13, wherein a step size value is determined and incorporated into the cost optimization result policy.
